(19) United States
(12) Patent Application Publication
(10) Pub. No.: US 2026/0253810 A1
(43) Pub. Date: Aug. 27, 2026

(54) SOLID ELECTROLYTIC CAPACITOR ELEMENT AND SOLID ELECTROLYTIC CAPACITOR

(71) Applicant: Panasonic Intellectual Property Management Co., Ltd., Osaka (JP)

(72) Inventors: RIE OKAMOTO, Osaka (JP); MASATOSHI TAKESHITA, Osaka (JP); KOHEI GOTO, Osaka (JP)

(21) Appl. No.: 19/162,671

(22) PCT Filed: Mar. 6, 2024
(86) PCT No.: PCT/JP2024/008417

§ 371 Date: Sep. 5, 2025

(30) Foreign Application Priority Data
Mar. 27, 2023 (JP) 2023-050148

(51) Int. Cl. H01G 9/025; H01G 9/04; H01G 9/048

(52) U.S. Cl. CPC H01G 9/025; H01G 9/048; H01G 2009/05

(57) ABSTRACT

A solid electrolytic capacitor element includes an anode body that includes a porous portion disposed at least in a surface layer of the anode body, a dielectric layer that covers at least a part of a surface of the anode body, and a solid electrolyte that covers at least a part of the dielectric layer. The anode body contains tantalum element, and the solid electrolyte contains sulfur element. The solid electrolyte includes a first part disposed in a void of the porous portion and a second part disposed in an outside of the porous portion that is outer from a principal surface of the anode body including the dielectric layer. In element mapping of a predetermined region of a cross-section of the porous portion using an electron probe micro analyzer, an abundance ratio of sulfur element is more than or equal to 0.17% with respect to an abundance ratio of tantalum element of 100%.

### TECHNICAL FIELD

The present disclosure relates to a solid electrolytic capacitor element and a solid electrolytic capacitor.

### BACKGROUND

A solid electrolytic capacitor includes a solid electrolytic capacitor element, a resin exterior body or a case that seals the solid electrolytic capacitor element, and an external electrode electrically connected to the solid electrolytic capacitor element. The solid electrolytic capacitor element includes an anode body, a dielectric layer formed on a surface of the anode body, and a cathode part that covers at least a part of the dielectric layer, for example. The cathode part includes a conductive polymer (for example, a conjugated polymer and a dopant) that covers at least a part of the dielectric layer. The conductive polymer is also referred to as a solid electrolyte.

From the viewpoint of simplifying formation of solid electrolyte, solid electrolyte is often formed using a method that uses a liquid dispersion that contains a conjugated polymer and a dopant.

For example, PTL 1 discloses a method for manufacturing an electrolytic capacitor including a step of impregnating an anode body having a dielectric film on a surface of the anode body, with a first dispersion solution containing particles of a first conductive polymer and a first solvent, and then impregnating the anode body with a second dispersion solution containing particles of a second conductive polymer and a second solvent, where the first dispersion solution has a pH closer to 7 than the pH of the second dispersion solution.

PTL 2 proposes a conductive polymer composite including poly(3,4-ethylenedioxythiophene) (PEDOT) and a polyanion, in which, when a peak intensity at 1260 cm⁻¹ of a Raman spectrum is denoted by I₁, a peak intensity at 1420 cm⁻¹ is denoted by I₂, an absorbance at a wavelength of 950 nm of a light absorption spectrum is denoted by A₁, and an absorbance at a wavelength of 2300 nm is denoted by A₂, conductive potential a derived by the following equation (I) is more than or equal to −0.23.

$$α = ( {I}_{1} / {I}_{2} ) - 0.135 \times ( {A}_{2} / {A}_{1} ) \qquad ( 1 )$$

### CITATION LIST

### Patent Literature

PTL 1: Unexamined Japanese Patent Publication No. 2013-58807
PTL 2: Unexamined Japanese Patent Publication No. 2021-134331

### SUMMARY

A first aspect of the present disclosure relates to a solid electrolytic capacitor element. The solid electrolytic capacitor element includes an anode body that includes a porous portion disposed at least in a surface layer of the anode body, a dielectric layer that covers at least a part of a surface of the anode body, and a solid electrolyte that covers at least a part of the dielectric layer. The anode body contains tantalum element, and the solid electrolyte contains sulfur element. The solid electrolyte includes a first part disposed in a void of the porous portion and a second part disposed in an outside of the porous portion that is outer from a principal surface of the anode body including the dielectric layer. In element mapping of a predetermined region of a cross-section of the porous portion using an electron probe micro analyzer, an abundance ratio of sulfur element is more than or equal to 0.17% with respect to an abundance ratio of tantalum element of 100%.

A solid electrolytic capacitor according to a second aspect of the present disclosure includes at least one solid electrolytic capacitor element described above.

In the solid electrolytic capacitor, fluctuation in equivalent series resistance (ESR) when the solid electrolytic capacitor is exposed to a high temperature can be reduced.

### BRIEF DESCRIPTION OF THE DRAWINGS

FIG. 1 is a schematic sectional view illustrating a solid electrolytic capacitor according to an exemplary embodiment of the present disclosure.

### DESCRIPTION OF EMBODIMENT

From the viewpoint of increasing a surface area to ensure a high capacitance, a porous portion having fine voids is formed at least in a surface layer of an anode body. A liquid dispersion contains a particulate conductive polymer in which a conjugated polymer is complexed with a polymer dopant (polymer anion or the like). Thus, when a solid electrolyte is formed by using the dispersion, it is difficult to fill the particulate conductive polymer up to a deep portion of the fine void, and it is difficult to increase a filling rate of the conductive polymer in the porous portion. In this case, an equivalent series resistance (ESR) when a solid electrolytic capacitor is exposed to a high temperature is likely to greatly fluctuate.

Since a method for forming the solid electrolyte using the dispersion is simple, it has become a mainstream of methods for forming the solid electrolyte in recent years. On the other hand, in a solid electrolytic capacitor element, the porous portion having the fine voids is formed on at least the surface layer of the anode body. The dielectric layer is formed along inner wall surfaces of cavities (may be referred to as pits.) in the surface of the anode body, including the inner wall surface of the voids of the porous portion. Thus, fine irregularities are formed on a surface of the dielectric layer in accordance with a shape of the surface of the anode body. The liquid dispersion contains a particulate conductive polymer (a conjugated polymer, a dopant, or the like) having a relatively high molecular weight. Moreover, in the liquid dispersion, a polymer anion having a high molecular weight is suitably used as the dopant from the viewpoint of having high affinity for the conjugated polymer and easily ensuring high stability and high heat resistance.

In a case where the solid electrolyte is formed by using the liquid dispersion, ESR tends to be high. This is estimated by the following reasons. Particles of the conductive polymer contained in the liquid dispersion fill near an opening of a fine recess on the surface of the dielectric layer in the porous portion, but hardly penetrate into the deep portion, and it is difficult to increase the filling rate of the conductive polymer. This tends to lead to an increase in initial ESR by increasing a resistance between the dielectric layer and the solid electrolyte. In addition, in a case where the filling rate of the conductive polymer in the porous portion is low, the voids are likely to serve as air flow paths. Due to an action of moisture or oxygen contained in air, the conductive polymer deteriorates due to oxidative deterioration of the conjugated polymer or dedoping of the dopant due to decomposition or the like, and thus, the conductivity of the conductive polymer deteriorates. Such deterioration of the conductive polymer is remarkable particularly in a high-temperature environment or a high-temperature and high-humidity environment. In addition, a volume change of the conductive polymer occurs in the high-temperature environment or the high-temperature and high-humidity environment. The movement of a first part held in the void is limited by a metal skeleton of the porous portion, whereas a second part easily moves with the volume change in the high-temperature environment or the high-temperature and high-humidity environment, and distortion easily occurs between the first part and the second part. Due to the occurrence of such distortion, a crack is generated between the surface of the first part or the porous portion and the second part, and the number of contact points is reduced. This is considered to increase a resistance between the first part or the porous portion and the second part. As a result, it is considered that the ESR greatly fluctuates when the solid electrolytic capacitor is exposed to the high-temperature environment or high-temperature and high-humidity environment.

As a method for forming the solid electrolyte other than the method using the liquid dispersion, there is also a method for forming the solid electrolyte by using in-situ polymerization such as chemical polymerization on the surface of the anode body including the dielectric layer. However, in the in-situ polymerization, it is difficult to control a polymerization reaction, and in general, it is difficult to obtain a uniform solid electrolyte, and types of raw material monomers and dopants of the conjugated polymer that can be used are limited. Actually, in the in-situ polymerization, a pyrrole compound is often employed, and a low molecular weight compound such as an aromatic sulfonic acid is used as the dopant. Thus, stability of the dopant and the conductive polymer is low, dedoping or deterioration of the conductive polymer easily occurs, and the ESR easily fluctuates when the solid electrolytic capacitor is exposed to the high-temperature environment or high-temperature and high-humidity environment.

In view of the above description, (1) a solid electrolytic capacitor element of the present disclosure includes an anode body including a porous portion disposed at least in a surface layer of the anode body, a dielectric layer covering at least a part of a surface of the anode body, and a solid electrolyte covering at least a part of the dielectric layer. The anode body contains tantalum element (Ta element), and the solid electrolyte contains sulfur element (S element). The solid electrolyte includes a first part disposed in a void of the porous portion, and a second part disposed an outside of the porous portion that is outer from a principal surface of in the anode body including the dielectric layer. In element mapping of a predetermined region of a cross-section of the porous portion using an electron probe micro analyzer, the abundance ratio of S element is more than or equal to 0.17% with respect to the abundance ratio of Ta element of 100%. Hereinafter, the solid electrolytic capacitor element may be simply referred to as a capacitor element.

In the present disclosure, the abundance ratio of S element is as relatively large as 0.17% or more with respect to the abundance ratio of Ta element in the porous portion, and thus, it is possible to reduce the fluctuation in the ESR when the solid electrolytic capacitor is exposed to the high temperature. S element is mainly derived from the conjugated polymer and the dopant contained in the solid electrolyte. For example, a polythiophene-based conjugated polymer includes S element in a thiophene ring, and the dopant includes S element derived from an anionic group such as a sulfo group. On the other hand, the anode body containing Ta element mainly contains Ta or a Ta alloy, and the dielectric layer contains Ta oxide. Thus, the abundance ratio of S element being relatively high with respect to the abundance ratio of Ta element in the porous portion means that a ratio of the solid electrolyte contained in the porous portion is relatively high (in other words, the filling rate of the solid electrolyte in the void of the porous portion is increased). In the present disclosure, by ensuring that the abundance ratio of S element in the porous portion is within the range mentioned above, a relatively high filling rate of the solid electrolyte is ensured, and thus, it is possible to reduce the paths for air flows, and to inhibit the progress of deterioration of the solid electrolyte. In addition, since the solid electrolyte is disposed in the void of the porous portion at a high filling rate, it is considered that a relatively large number of contact points are maintained between the first part or the porous portion and the second part even though the volume of the solid electrolyte changes due to the exposure of the solid electrolytic capacitor to the high-temperature environment or high-humidity environment. Accordingly, it is considered that the fluctuation in the ESR when the solid electrolytic capacitor is exposed to the high-temperature environment or high-temperature and high-humidity environment can be reduced.

A relatively high S element content in the porous portion as described above can be obtained, for example, by the following method. First, the dielectric layer is formed on the surface of the anode body containing Ta element and containing the porous portion at least on the surface layer, and the obtained anode body having the dielectric layer on the surface is subjected to a pre-coating treatment, then immersed in a polymerization liquid containing a precursor of the conjugated polymer and the polymer anion containing S element, and electrolytically polymerized by a three-pole method. By the pre-coating treatment, the surface of the dielectric layer is covered with a conductive material with a certain degree of coverage, and a pre-coating layer of the conductive material is formed. Many regions of the surface of the dielectric layer is covered with the pre-coating layer, and thus, electrolytic polymerization easily proceeds. As described above, it is considered that, by the coating with the pre-coating layer and the three-pole electrolytic polymerization, in the fine void of the anode body including the dielectric layer, the polymerization of the precursor of the conjugated polymer gradually proceeds in the presence of a polymer anion having relatively high stability as the dopant, the conductive polymer in which the conjugated polymer and the polymer anion interact with each other is generated, and a dense solid electrolyte is formed. Many regions of the dielectric layer including the inner surface of the fine void of the porous portion are pre-coated. In addition, since the precursor and the polymer anion are dissolved in the polymerization liquid, the precursor and the polymer anion easily penetrate into the deep portion of the fine void of the porous portion. Thus, polymerization easily proceeds only near the opening of the void but also in the deep portion inside the void. Accordingly, the void can be filled with the solid electrolyte at a high filling rate. Inside the void of the porous portion, since the precursor of the conjugated polymer goes through polymerization while interacting with the polymer anion, it is possible to achieve a highly oriented conjugated polymer with the polymer anion dispersed relatively uniformly. In this manner, there is a tendency that high doping concentration can be achieved. Thus, the conductivity of the solid electrolyte in the first part can be increased, and dedoping or deterioration of the conjugated polymer hardly occurs in a case where the solid electrolytic capacitor is exposed to the high-temperature environment or high-temperature and high-humidity environment. In addition, since the filling rate of the solid electrolyte in the porous portion is high, even though the volume of the solid electrolyte changes in a case where the solid electrolytic capacitor is exposed to the high-temperature environment or high-temperature and high-humidity environment, the contact point between the first part or the porous portion and the second part is maintained. Accordingly, excellent advantages such as the advantages described above can be achieved. In addition, in the present disclosure, the filling rate of the solid electrolyte in the porous portion is high. Thus, the resistance of the first part can be suppressed low from an initial stage, and the initial ESR can be suppressed low. The resistance of the first part is low, and thus, a relatively high initial capacitance can be ensured.

Note that, even in a case where the first part is formed by using the liquid dispersion containing the conjugated polymer containing S element such as PEDOT and the polymer anion containing S element such as polystyrene sulfonic acid (PSS), the abundance ratio of S element in the porous portion is low. It is highly likely that this is because the filling rate of the solid electrolyte in the porous portion is low, even with the use of the liquid dispersion. In addition, the abundance ratio of S element in the porous portion is low and is less than 0.17% even in a case where the pre-coating treatment is not performed or the coverage by the pre-coating layer is low even though the pre-coating treatment is performed.

The three-pole electrolytic polymerization is performed by using three electrodes of an anode body having a dielectric layer formed on a surface, a counter electrode, and a reference electrode. With the three-pole electrolytic polymerization, a potential of an anode can be controlled precisely by using the reference electrode, without being affected by a change in a natural potential of the counter electrode. In the case of the three-pole type, it is considered that an electrolytic polymerization reaction is more precisely controlled and a polymer chain slowly grows while interacting with the polymer anion as compared with the case of a two-pole type using an anode body and a counter electrode. Accordingly, the conjugated polymer formed has a high orientation and includes a better dispersed polymer anion, and a more uniform and denser solid electrolyte is formed. In addition, the coverage by the pre-coating layer is high, and thus, the polymerization reaction easily proceeds in the void of the porous portion. Accordingly, it is considered that a more uniform and denser solid electrolyte is formed in the void of the porous portion at a high filling rate. In addition, the polymer anion is highly dispersed, and thus, it is possible to achieve a relatively high doping concentration, and the conductivity itself of the solid electrolyte can be improved.

Note that, taking the volume of the void in the porous portion into consideration, the abundance ratio of S element is less than or equal to 5%, for example.

Analysis by an electron probe micro analyzer (EPMA) is performed by using a sample in which a cross-section of a porous portion of a portion where a cathode part containing a solid electrolyte is formed is exposed and a platinum film is formed in a capacitor element. In a sectional image of the porous portion in which the solid electrolyte is formed, element mapping is performed from a difference in a wavelength of characteristic X-rays by EPMA for a region from one principal surface of the anode body to a depth of 450 μm and a width of 450 μm of the porous portion, and a Net intensity of contained elements is measured. The Net intensity is a value obtained by removing a background (noise) from a measurement value of each element. A ratio (%) of the Net intensity of S element when the Net intensity of Ta element is 100% is obtained. The ratio (%) of the Net intensity of S element is obtained for each of a plurality of regions (for example, five regions). An average value is calculated, and the abundance ratio (%) of S element when the abundance ratio of Ta element in the porous portion is 100% is determined.

Conditions of the EPMA analysis are as follows.
Environment at the time of measurement: 25° C., atmospheric pressure
Acceleration voltage: 15.0 kV
Beam current: 50.4 nA
Integration time: 50.0 ms/point (12 minutes mode)
Spectroscopic crystals: AP/CH1, PbST/CH2, PET/CH3, LiF/CH4, LSA80/CH5

The sample used for the analysis can be produced by following the steps below, for example. First, a solid electrolytic capacitor or a capacitor element is embedded in a curable resin, and the curable resin is cured. The anode body includes a first end part and a second end part opposite to the first end part, and the solid electrolyte is formed in a part of the anode body, the part being close to the second end part. The cured product obtained above is subjected to wet polishing or dry polishing so that a cross-section perpendicular to a length direction of the capacitor element and parallel to a thickness direction thereof is exposed at a predetermined position in a direction from the first end part toward the second end part of the anode body (i.e., a length direction of the anode body or the capacitor element). The exposed cross-section is smoothed by ion milling. Platinum (Pt) is sputtered on the smoothed cross-section using a sputtering apparatus, to form a platinum film having a thickness of 1 nm to 2 nm. In this way, the sample for analysis is obtained. Note that, when a length of a region where the solid electrolyte is formed in a direction parallel to the length direction of the capacitor element is defined as 1, the cross-section is taken at a position in a range of more than 0 and less than or equal to 0.05, from an end part of the region where the solid electrolyte is formed, the end part being close to the second end part.

(2) In the configuration of the above (1), the first part may contain a first polymer component corresponding to the conjugated polymer and a second polymer component corresponding to the polymer anion containing S element. In a case where the first component includes these polymer components (in particular, the second polymer component), it is difficult to increase the filling rate of the solid electrolyte in the first part. In the present disclosure, since the first part is formed by the pre-coating treatment and the three-pole electrolytic polymerization, the abundance ratio of S element in the porous portion can be increased even in a case where the first part includes the above-described polymer component, and a high filling rate of the solid electrolyte can be ensured.

(3) In the configuration of the above (2), the first polymer component may contain S element. In this case, it is easy to increase the abundance ratio of S element in the porous portion. In addition, higher conductivity of the first part is easily obtained.

(4) The configuration of the above (2) or (3), in a Raman spectrum of the first part, a ratio Iₚ₁/Iₚ₂ of an intensity Iₚ₁ of a first peak unique to the first polymer component to an intensity Iₚ₂ of a second peak unique to the second polymer component may be more than or equal to 2. In this case, since the orientation and crystallinity of the conjugated polymer in the first part are relatively high, it is easy to ensure high conductivity of the solid electrolyte.

(5) In the configuration of the above (4), the ratio Iₚ₁/Iₚ₂ may be less than or equal to 7. In this case, a relatively high doping concentration is easily obtained, and higher conductivity of the solid electrolyte is obtained. Thus, it is advantageous in suppressing ESR to a low level.

(6) In the configuration of any one of the above (2) to (5), in the first part, the conjugated polymer may include a monomer unit corresponding to a thiophene compound. The polymer anion may include a monomer unit corresponding to an aromatic sulfonic acid compound. In the Raman spectrum of the first part, the first peak unique to the first polymer component may be observed in a range from 1200 cm⁻¹ to 1600 cm⁻¹ inclusive. In addition, in the Raman spectrum of the first part, the second peak unique to the second polymer component may be observed in a range from 800 cm⁻¹ to 1100 cm⁻¹ inclusive. In such a case, since high conductivity of the solid electrolyte is easily obtained in the first part, it is advantageous in suppressing ESR to a low level.

(7) In the configuration of any one of the above (2) to (6), weight-average molecular weight Mw of the polymer anion may be in a range from 100 to 500,000 inclusive. Even though the weight-average molecular weight of the polymer anion is in such a range, the solid electrolyte can be disposed in the void of the porous portion at a high filling rate by the pre-coating treatment and the three-pole electrolytic polymerization, and high conductivity of the first part is easily obtained. In addition, higher stability of the conductive polymer is obtained. Accordingly, the fluctuation in the ESR in a case where the solid electrolytic capacitor is exposed to the high-temperature environment or high-temperature and high-humidity environment can be further reduced.

(8) In the configuration of any one of (1) to (7), the anode body may be a porous sintered body. In the case of an anode foil including a dielectric layer, an average depth of pores of the porous portion is about several tens of μm. By contrast, in the porous sintered body, the average depth of the pores of the porous portion in the anode body including the dielectric layer is, for example, more than or equal to 100 μm, and usually more than or equal to 300 μm. Thus, in the porous sintered body, it is difficult to dispose the solid electrolyte at a high filling rate in the porous portion as compared with the case of the anode foil. In the present disclosure, even in a case where the anode body is the porous sintered body, since the solid electrolyte can be disposed at a high filling rate in the porous portion by the pre-coating treatment and the three-pole electrolytic polymerization, high conductivity is obtained, and the flow of air in the pores is reduced. As a result, the deterioration of the conductive polymer is suppressed. Accordingly, even in a case where the anode body is the porous sintered body, it is possible to suppress the fluctuation in the ESR in a case where the solid electrolytic capacitor is exposed to the high-temperature environment or high-temperature and high-humidity environment.

(9) The present disclosure also includes a solid electrolytic capacitor element including at least one of the capacitor elements according to any one of the above (1) to (8).

Hereinafter, the capacitor element and the solid electrolytic capacitor of the present disclosure including the configurations of the above (1) to (9) will be described more specifically. To the extent that there is no technical contradiction, at least one configuration of the above (1) to (9) and at least one of the following elements may be combined.

### [Capacitor Element]

The capacitor element includes an anode part and a cathode part.

### (Anode Part)

The anode part includes an anode body. The anode part may include the anode body and an anode wire.

### (Anode Body)

The anode body contains Ta element. Ta functions as a valve metal. The anode body may contain Ta metal, may contain a Ta alloy, or may contain both of the Ta metal and the Ta alloy.

The anode body includes a porous portion at least in a surface layer. The anode body includes many fine voids in the porous portion. This kind of porous portion allows the anode body to have a fine uneven shape.

Examples of the anode body include a porous molded body of particles containing Ta element or a porous sintered body (a sintered body of a porous molded body or the like). In these anode bodies, the whole anode body is the porous portion. Each of the porous molded body and the porous sintered body may have a sheet shape, a rectangular parallelepiped shape, a cubic shape, or a shape similar thereto. The anode body including the porous portion in the surface layer is obtained by roughening a surface of a base material (for example, a base material in a sheet shape (for example, a foil shape or a plate shape)) containing Ta element, for example. The roughening may be performed by etching (electrolytic etching, chemical etching, or the like) or the like, for example. This kind of anode body includes, for example, a core part and a porous portion formed integrally with the core part, the porous portion existing in both surfaces of the core part. As the anode body, a porous sintered body containing Ta element is preferable.

The anode body may include an anode lead-out part including a first end part, and a cathode formation part including a second end part opposite to the first end part. The cathode formation part of the anode body has a surface on which the cathode part including the solid electrolyte is formed. The anode lead-out part is used for electrical connection with an external electrode on an anode side, for example. To the anode lead-out part, an anode lead terminal may be connected.

### (Anode Wire)

In a case where the anode body is a porous sintered body or a porous molded body, the anode part may include the anode wire. The anode wire may be made of metal. Examples of the material of the anode wire include the valve metal, copper, and a copper alloy. Examples of the valve metal include aluminum, tantalum, niobium, and titanium. The anode wire includes a part embedded in the anode body, and a remaining part protruding outward from an end surface of the anode body. The anode wire protruding outward has an end part corresponding to the first end part, and the anode body has an end part opposite to the first end part, the end part corresponding to the second end part.

### (Dielectric Layer)

The dielectric layer is formed so as to cover at least a part of a surface (for example, a surface of at least a part of the porous portion) of the anode body. The dielectric layer is an insulating layer functioning as a dielectric material. The dielectric layer is formed by anodizing the tantalum (Ta) of the surface of the anode body. In a case where the dielectric layer is formed on the surface of the porous portion of the anode body, the surface of the dielectric layer has a fine irregularity shape along the shape of the porous portion.

As described above, in the porous molded body or the porous sintered body (in particular, the porous sintered body), it is difficult to dispose the solid electrolyte in the pore at a high filling rate due to the average depth of the pores of the porous portion as compared with the case of the anode foil. When the filling rate of the solid electrolyte in the porous portion is low, air easily enters, and the solid electrolyte deteriorates due to deterioration of the conjugated polymer, dedoping of the dopant, and the like by an action of moisture or oxygen. In addition, the first part is peeled off from the second part and falls into the pore due to deterioration of the solid electrolyte and stress in a case where the solid electrolyte is exposed to the high-temperature environment (or high-temperature and high-humidity environment). As a result, the conductivity of the solid electrolyte deteriorates. The deterioration of the solid electrolyte is remarkable particularly in a case where the solid electrolytic capacitor is exposed to the high-temperature environment or high-temperature and high-humidity environment. Thus, in a solid electrolytic capacitor using an anode body that is porous as a whole, such as a porous molded body or a porous sintered body (in particular, a porous sintered body), the fluctuation in the ESR is likely to be remarkable in a case where the solid electrolytic capacitor is exposed to the high-temperature environment or high-temperature and high-humidity environment. In the present disclosure, even in a case where the entire anode body is porous (in a case where a porous sintered body is used), the abundance ratio of S element in the porous portion can be increased, and the solid electrolyte can be disposed in the pores at a high filling rate. Accordingly, the fluctuation in the ESR in a case where the solid electrolytic capacitor is exposed to the high-temperature environment or high-temperature and high-humidity environment can be reduced.

The dielectric layer may be formed of a material that functions as a dielectric layer. An example of such a material of the dielectric layer includes an oxide of a valve metal. Since the anode body contains Ta element, the dielectric layer formed by anodizing usually contains Ta₂O₅. However, the dielectric layer is not limited to these specific examples.

### (Cathode Part)

The cathode part at least includes a solid electrolyte covering at least a part of the dielectric layer. The solid electrolyte is formed in a portion on the second end part side of the anode body (in other words, the cathode formation part) with the dielectric layer interposed therebetween. The cathode part usually includes a solid electrolyte covering at least a part of the dielectric layer, and a cathode lead-out layer covering at least a part of the solid electrolyte. The solid electrolyte and the cathode lead-out layer will now be described.

### (Solid Electrolyte)

In the present disclosure, the solid electrolyte contains S element. In addition, the solid electrolyte includes a first part disposed in the void of the porous portion of the anode body including the dielectric layer, and a second part disposed in an outside of the porous portion that is outer from a principal surface of the anode body including the dielectric layer.

The solid electrolyte includes the conductive polymer. The conductive polymer includes a non-self-doped conductive polymer (a conjugated polymer, a dopant, or the like). The solid electrolyte may further contain a self-doped conductive polymer. In addition, the solid electrolyte may further contain an additive agent as necessary. S element contained in the solid electrolyte is mainly derived from the conductive polymer. More specifically, S element is included at least in the dopant, and may be included in both of the dopant and the conjugated polymer. In addition, S element is included in at least the first part, and is usually included in both of the first part and the second part.

### (First Part)

At least a part of the solid electrolyte of the first part is formed by three-pole electrolytic polymerization as described above. The first part may contain a first polymer component corresponding to a conjugated polymer and a second polymer component corresponding to a polymer anion containing S element. The solid electrolyte of the first part may include a pre-coating layer containing a conductive polymer as a conductive material.

Examples of the conjugated polymer corresponding to the first polymer component include known conjugated polymers used in solid electrolytic capacitors, such as n-conjugated polymers. The conjugated polymer corresponding to the first polymer component is usually a non-self-doped conjugated polymer (for example, a conjugated polymer having no anionic group). Examples of the conjugated polymer described above include a polymer having polypyrrole, polythiophene, polyaniline, polyfuran, polyacetylene, polyphenylene, polyphenylene vinylene, polyacene, or polythiophene vinylene as a basic skeleton. The polymer is required to contain at least one monomer unit constituting the basic skeleton. The monomer units also include a monomer unit having a substituent. The polymer also includes a homopolymer, and a copolymer of two or more monomers. Examples of polythiophene include poly(3,4-ethylenedioxythiophene) (PEDOT).

From the viewpoint of easily increasing the abundance ratio of S element, the first polymer component may contain S element. The conjugated polymer constituting such a first polymer component includes, for example, a monomer unit (preferably, a repeating structure of the monomer unit) corresponding to a thiophene compound. When a thiophene compound is used as a precursor, it becomes possible to promote the electrolytic polymerization even in the presence of the polymer anion including S element, by adjusting the conditions of the electrolytic polymerization. This feature is more advantageous in improving the abundance ratio of S element. Examples of the thiophene compound include a compound having a thiophene ring and capable of forming a repeated structure of a corresponding monomer unit. Such a thiophene compound can form the repeated structure of monomer units by becoming linked at the 2-position and the 5-position of the thiophene ring.

The thiophene compound may have a substituent at at least one of the 3-position and the 4-position of the thiophene ring, for example. The substituent at the 3-position and the substituent at the 4-position may become linked to form a ring fused to a thiophene ring. Examples of the thiophene compound include thiophene which may have a substituent at at least one of the 3- and 4-positions and an alkylene dioxythiophene compound (for example, C₂₋₄ alkylenedioxythiophene compound such as ethylenedioxythiophene compound). The alkylene dioxythiophene compound also includes a compound having a substituent in a part of an alkylene group.

The substituent is preferably, but is not limited to, an alkyl group (for example, a C₁₋₄ alkyl group such as a methyl group and an ethyl group), an alkoxy group (for example, a C₁₋₄ alkoxy group such as a methoxy group and an ethoxy group), a hydroxy group, or a hydroxyalkyl group (for example, a hydroxy C₁₋₄ alkyl group such as a hydroxymethyl group), for example. In a case where the thiophene compound has two or more substituents, each of the substituents may be the same, or different from the other.

A conjugated polymer (PEDOT or the like) at least including a monomer unit (preferably, a repeating structure of the monomer unit) corresponding to a 3,4-ethylenedioxythiophene compound (3,4-ethylenedioxythiophene (EDOT) or the like) may be used. The conjugated polymer at least including a monomer unit corresponding to EDOT may include only the monomer unit corresponding to EDOT, or may include a monomer unit corresponding to another thiophene compound, in addition to the monomer unit corresponding to EDOT.

The weight-average molecular weight (Mw) of the conjugated polymer is not particularly limited, and may range, for example, from 1,000 to 1,000,000, inclusive.

Note that, the weight-average molecular weight (Mw) herein is a value in terms of polystyrene measured by gel permeation chromatography (GPC). Note that, usually, GPC is measured using a polystyrene gel column, and water and methanol (volume ratio 8:2) as a mobile phase.

The first part may include the second polymer component corresponding to the polymer anion including S element, as the dopant. Examples of the polymer anion included in the second polymer component include polymers having a plurality of sulfo groups. By using the second polymer component, the abundance ratio of S element in the first part can be increased easily. The polymer anion may also include another anionic group (for example, a carboxy group), in addition to the sulfo group.

In the solid electrolyte, the anionic group (a sulfo group, a carboxy group, or the like) of the dopant may be included in the free form, in the form of anions, or in the form of salt, or may be included in the form bonded to or interacting with the conjugated polymer. In the description herein, an anionic group in any of these forms will be sometimes simply referred to as an “anionic group”, a “sulfo group”, a “carboxy group”, or the like.

One example of the polymer anion having a sulfo group is a polymeric sulfonic acid. Specific examples of the polymer anion include polyvinylsulfonic acid, polystyrenesulfonic acid (including a copolymer and a substituted compound having a substituent), polyallylsulfonic acid, polyacrylsulfonic acid, polymethacrylsulfonic acid, poly(2-acrylamide-2-methylpropanesulfonic acid), polyisoprenesulfonic acid, polyestersulfonic acid (for example, aromatic polyester sulfonic acid), and phenolsulfonic acid novolac resin. However, the polymer anion is not limited to these specific examples. The solid electrolyte may contain one kind of polymer anion or two or more kinds of polymer anion in combination.

The Mw of the polymer anion is, for example, in a range from 100 to 500,000, inclusive. Even though the weight-average molecular weight of the polymer anion is in such a range, the solid electrolyte can be disposed in the void of the porous portion at a high filling rate by the pre-coating treatment and the three-pole electrolytic polymerization, and high conductivity of the first part is easily obtained. In addition, higher stability of the conductive polymer is obtained. Accordingly, the fluctuation in the ESR in a case where the solid electrolytic capacitor is exposed to the high-temperature environment or high-temperature and high-humidity environment can be further reduced. From the viewpoint of easily disposing the conductive polymer in the void of the porous portion at a high filling rate, the Mw of the polymer anion contained in at least the first part is preferably less than or equal to 100,000, more preferably from 1000 to 100,000, inclusive, or from 10,000 to 100,000, inclusive. In addition, with Mw of the polymer anion within such a range, there are tendencies that the polymer anion becomes better dispersed, and the doping concentration becomes relatively high, in the first part. This setting is therefore advantageous in ensuring higher conductivity. In addition, there is a tendency that the dopant and the conductive polymer become highly stabilized.

In the first part, the amount of the dopant contained in the solid electrolyte may be in a range from 10 parts by mass to 1000 parts by mass, inclusive, and may be in a range from 20 parts by mass to 500 parts by mass, inclusive, with respect to 100 parts by mass of the conjugated polymer. The amount may be in a range from 50 parts by mass to 200 parts by mass, inclusive, from the viewpoint of improving the dispersibility of the polymer anion and achieving a relatively high doping concentration.

The pre-coating layer contains, for example, a conductive material (a conductive polymer or the like). The conductive polymer constituting the pre-coating layer preferably includes at least a self-doped conductive polymer, and may include a non-self-doped conductive polymer in addition to the self-doped conductive polymer. The pre-coating layer is formed by using, for example, a liquid composition (liquid dispersion, solution, or the like) containing the self-doped conductive polymer.

The self-doped conductive polymer has, for example, a skeleton of a conjugated polymer and a functional group (an anionic group or the like) that functions as a dopant directly or indirectly bonded to the skeleton by a covalent bond. Examples of the conjugated polymer corresponding to the skeleton of the conjugated polymer include conjugated polymers (π-conjugated polymers and the like) illustrated as the conjugated polymer corresponding to the first polymer component. From the viewpoint of easily obtaining high conductivity and the like, the self-doped conductive polymer is preferably a polymer having a skeleton of a conjugated polymer including a repeating structure of a monomer unit corresponding to a thiophene compound and an anionic group introduced into the skeleton.

The self-doped conductive polymer may have a skeleton of a conjugated polymer (PEDOT or the like) including a repeating structure of a monomer unit corresponding to at least a 3,4-ethylenedioxythiophene compound (EDOT or the like). The skeleton of the conjugated polymer at least including the repeating structure of the monomer unit corresponding to EDOT may include only the monomer unit corresponding to EDOT, or may include a monomer unit corresponding to another thiophene compound, in addition to the monomer unit corresponding to EDOT.

Examples of the anionic group include a sulfo group, a carboxy group, a phosphate group, and a phosphonic acid group. The self-doped conductive polymer may contain one kind or two or more kinds of anionic groups. From the viewpoint of easily ensuring higher conductivity of the self-doped conductive polymer, the self-doped conductive polymer may contain at least a sulfo group.

The anionic group may be directly introduced into the skeleton of the conjugated polymer, or may be introduced via a linking group. The linking group is preferably a polyvalent group (divalent group) containing an alkylene group. Examples of the linking group include an aliphatic polyvalent group (divalent group or the like) such as an alkylene group, and a —R¹—X—R²-group (X is oxygen element or sulfur element, and R¹ and R² are the same or different and each represent an alkylene group.). The number of carbon atoms of each alkylene group contained in the linking group is, for example, from 1 to 10, inclusive, and may be from 1 to 6, inclusive. The alkylene group may be linear or branched. The linking group may include, for example, at least an alkylene group in which the number of carbon atoms is more than or equal to 2. The number of carbon atoms in such an alkylene group may be from 2 (or 3) to 10, inclusive, or may be from 2 (or 3) to 6, inclusive. For example, R¹ may be an alkylene group in which the number of carbon atoms is from 1 to 6, inclusive, and R² may be an alkylene group in which the number of carbon atoms is from 2 (or 3) to 10, inclusive. However, the linking group is not limited thereto.

In the pre-coating layer or the first part, the anionic group of the self-doped conductive polymer may be contained in any form of anion, free, ester, salt, or the like, or may be contained in a form of interaction with or complexed with the component contained in the first part. In the present specification, all of these forms are simply referred to as anionic groups.

The Mw of the self-doped conductive polymer may be from 1,000 to 1,000,000, inclusive, or from 1,000 to 50,000, inclusive.

The pre-coating layer may contain one self-doped conductive polymer, or may contain two or more self-doped conductive polymers in combination.

### (Raman Spectrum)

In the capacitor element of the present disclosure, in the Raman spectrum of the first part, at least the first peak unique to the first polymer component (conjugated polymer) and the second peak unique to the second polymer component are observed. A main component of the solid electrolyte is the conjugated polymer, and in the Raman spectrum of the solid electrolyte, the peak (first peak) attributed to CC stretching vibration derived from the conjugated polymer is the highest, and the height is characteristic. The solid electrolyte in the first part has high crystallinity due to the highly orientated conjugated polymer. In addition, in the first part, the conjugated polymer in the solid electrolyte is energetically stable. Thus, the first part exhibits a characterizing Raman spectrum, in which the first peak and the second peak described above are observed.

For example, in the first part, in a case where the conjugated polymer contains the monomer unit corresponding to the thiophene compound and the polymer anion contains the monomer unit corresponding to the aromatic sulfonic acid compound, in the Raman spectrum of the first part, the first peak is observed in a range from 1200 cm⁻¹ to 1600 cm⁻¹, inclusive, and the second peak is observed in a range from 800 cm⁻¹ to 1100 cm⁻¹, inclusive. The first peak is attributed to the C═C stretching vibration of the thiophene ring in the monomer unit corresponding to the thiophene compound. This second peak is attributed to the C—S stretching vibration between the aromatic ring and S element of the sulfo group in the monomer unit corresponding to the aromatic sulfonic acid compound. For example, in a case where the conjugated polymer includes at least a monomer unit corresponding to EDOT, the position of the first peak is in a range from 1400 cm 1 to 1450 cm⁻¹, inclusive, and may be in a range from 1410 cm⁻¹ to 1435 cm⁻¹, inclusive. In a case where the polymer anion includes at least polystyrene sulfonic acid, the position of the second peak is in a range from 900 cm⁻¹ to 10⁵⁰ cm⁻¹ inclusive, and may be in a range from 950 cm⁻¹ to 10⁵⁰ cm⁻¹, inclusive, for example.

On the other hand, in the Raman spectrum of the first part of the solid electrolyte formed by using the liquid dispersion, the characterizing peaks described above are not observed. This is possibly because fluorescence emission inhibits the observation of Raman scattered light. In the preparation of the liquid dispersion, polymerization takes place in the liquid phase. Therefore, in the particles of the conductive polymer thus obtained, polymer anions having a high molecular weight segregate more to the surface, than that in the precursor of the conjugated polymer. It is considered that, in a case where the liquid dispersion is used, since the particles of the conductive polymer with the polymer anions segregated on the surface are disposed in the porous portion, the characterizing peaks are not observed in the Raman spectrum of the first part, due to the fluorescence emission from the segregated polymer anions.

In the capacitor element of the present disclosure, in the Raman spectrum of the first part, a ratio Iₚ₁/Iₚ₂ of the intensity Iₚ₁ of the first peak unique to the first polymer component (conjugated polymer) to the intensity Iₚ₂ of the second peak unique to the second polymer component (polymer anion) may be more than or equal to 2, more than or equal to 3, or more than or equal to 4. In a case where the ratio Iₚ₁/Iₚ₂ is within such a range, the conjugated polymer in the first part exhibits relatively high orientation and crystallinity. Thus, high conductivity can be achieved in the solid electrolyte of the first part. From the viewpoint of easily ensuring higher crystallinity and conductivity, the ratio Iₚ₁/Iₚ₂ may be more than or equal to 5 or more than or equal to 5.5. The ratio Iₚ₁/Iₚ₂ is, for example, less than or equal to 10. The ratio Iₚ₁/Iₚ₂ is preferably less than or equal to 7, from the viewpoint of achieving a relatively high doping concentration to better ensure high conductivity. For example, the ratio Iₚ₁/Iₚ₂ is in a range from 2 to 10 (or to 7), inclusive, and may be in a range from 4 to 10 (or 7), inclusive. In these numerical ranges, the lower bound values may be replaced with the values mentioned above. Note that, a peak intensity herein corresponds to a peak height resultant of subtracting the height of the background from the height of each peak.

In the present specification, the Raman spectrum of the solid electrolyte of the first part is measured for the solid electrolyte present in the cross-section of the porous portion at a predetermined position of the solid capacitor element under the following conditions.
Raman spectrometer: RamanFORCE PAV manufactured by NanoPhoton Corporation
Diffraction grating: 600 gr/cm
Measurement wavenumber range: from 0 cm⁻¹ to 2500 cm⁻¹, inclusive
Temperature: 25° C.

The wavelength of the laser light emission, the laser power density, and the exposure time are determined depending on the type of the conjugated polymer. For example, in a case where the conjugated polymer is PEDOT, the laser light emission wavelength is set to 784.73 nm, the laser power density is set to 870 W/cm², and the exposure time is set to 60 seconds.

For the measurements of a Raman spectrum, a sample collected by the following steps may be used. First, a solid electrolytic capacitor or a capacitor element is embedded in a curable resin, and the curable resin is cured. Polishing treatment or cross-section polishing processing is applied to the cured product to expose a cross-section of the cured product, the cross-section being parallel with the thickness direction and perpendicular to the length direction of the capacitor element. When the length of the region where the solid electrolyte is formed in the direction parallel to the length direction of the capacitor element is defined as 1, the cross-section is taken at a position in a range of more than 0 and less than or equal to 0.05, from an end part of the region where the solid electrolyte is formed, the end part being an end part on the opposite side of the anode lead-out part (the end part on the side of the second end part). In this way, the sample for the measurement is obtained. The Raman spectrum is then measured, on the exposed cross-section of the sample, from a region of 8 μm×8 μm of the solid electrolyte (first part) inside the void on the surface of the porous portion. The intensities of the first peak and the second peak are then calculated by averaging the values measured at 12 points in the region of 8 μm×8 μm of the first part inside the void of the porous portion.

### (Method for Forming Solid Electrolyte)

The solid electrolyte of at least the first part can be formed by performing the pre-coating treatment on the surface of the dielectric layer and then performing the three-pole electrolytic polymerization of the precursor of the conjugated polymer in the presence of the dopant. For example, the pre-coating treatment is performed on the anode body including the dielectric layer in the liquid composition (polymerization liquid) containing the precursor of the conjugated polymer and the dopant, and then electrolytic polymerization is performed in a state where a cathode formation part of the anode body is immersed. Conditions of the pre-coating treatment and conditions of the electrolytic polymerization are adjusted, and thus, the solid electrolyte can be disposed in the fine void of the porous portion of the anode body containing Ta element at a high filling rate. As a result, the abundance ratio of S element can be increased. In addition, it is also possible to dope the dopant at a relatively high doping concentration, to ensure the high conductivity of the solid electrolyte, and to stabilize the conjugated polymer in terms of energy. Accordingly, since the deterioration of the solid electrolyte in a case where the solid electrolytic capacitor is exposed to the high-temperature environment or high-temperature and high-humidity environment can be suppressed and high conductivity is maintained, the fluctuation in the ESR can be reduced.

Examples of the precursor of the conjugated polymer include a raw material monomer of the conjugated polymer, and an oligomer and a prepolymer in which a plurality of molecular chains of the raw material monomer are linked. One type of precursor may be used, or two or more types of precursor may be used in combination. From the viewpoint for achieving a conjugated polymer with better orientation, at least one selected from the group consisting of a monomer and an oligomer (in particular, monomer) is preferably used as the precursor.

The liquid composition typically contains a solvent. Examples of the solvent include water, an organic solvent, and a mixed solvent of water and an organic solvent (a water-soluble organic solvent or the like).

In a case where another conductive material, an additive, and the like are used, they may be added to the liquid composition.

The liquid composition may contain an oxidizing agent as necessary. In addition, the oxidizing agent may be applied to the anode body before or after the liquid composition is brought into contact with the anode body on which the dielectric layer is formed. Examples of such an oxidizing agent include a compound (a ferrous sulfate or the like) capable of generating Fe³⁺, a persulfate (a sodium persulfate, an ammonium persulfate, or the like), and a hydrogen peroxide. One type of oxidizing agent may be used alone, or two or more types of oxidizing agent may be used in combination.

The three-pole electrolytic polymerization is performed in a state in which the anode body, the counter electrode, and the reference electrode are immersed in the liquid composition. As the counter electrode, for example, a Ti electrode is used, but the counter electrode is not limited thereto. As the reference electrode, a silver/silver chloride electrode (Ag/Ag⁺) is preferably used.

In the electrolytic polymerization, a voltage (polymerization voltage) applied to the anode body is, for example, in a range from 0.6 V to 1.5 V, inclusive. The polymerization voltage is preferably in a range of more than 0.9 V and less than or equal to 1.2 V (or less than or equal to 1.1 V), may be in a range from 1.0 V to 1.2 V, inclusive, and may be in a range from 1.0 V to 1.1 V, inclusive, from the viewpoint of easily disposing the conductive polymer in the void of the porous portion at a high filling rate and easily ensuring relatively high crystallinity of the solid electrolyte. By carrying out the three-pole electrolytic polymerization at such a polymerization voltage, the polymerization reaction in the voids can be controlled precisely. Accordingly, a polymer chain of the conjugated polymer can be grown inside the void in a state where the dopant is highly dispersed, and the solid electrolyte can be disposed in the void at a high filling rate. In addition, because the polymerization is allowed to take place slowly, it is possible to achieve a conjugated polymer with improved orientation and crystallinity, to achieve a relatively high doping concentration, and to ensure a relatively high conductivity. Note that, the polymerization voltage is a potential of the anode body with respect to a reference electrode (silver/silver chloride electrode (Ag/Ag⁺)).

The electrolytic polymerization may be carried out at a temperature in a range from 5° C. to 60° C., inclusive, or in a range from 15° C. to 35° C., inclusive, for example.

Prior to the electrolytic polymerization, the pre-coating treatment is performed on the surface of the dielectric layer. The pre-coating treatment is performed by using, for example, a conductive material (a conductive polymer or the like). The pre-coating treatment may be performed by using either the self-doped conductive polymer or the non-self-doped conductive polymer. The pre-coating treatment may be performed by using the liquid composition (liquid dispersion, solution, or the like) containing at least the self-doped conductive polymer.

The liquid dispersion used in the pre-coating treatment contains the conductive polymer having a smaller particle size at a lower concentration, compared with the liquid dispersion used in a case where the solid electrolyte constituting the cathode part is formed. For example, an average primary particle size of the particles of the conductive polymer contained in the liquid dispersion for the pre-coating treatment may be less than or equal to 100 nm, and may be less than or equal to 60 nm. The concentration of the dry solid content of the liquid dispersion is, for example, less than or equal to 1.2 mass %. Note that, the conductive polymer in the liquid dispersion used in forming the solid electrolyte by which the cathode part is formed usually has particles with an average primary particle size more than or equal to 200 nm, and a dry solid content concentration more than or equal to 2 mass %. The conjugated polymer used in the pre-coating treatment (or the conjugated polymer forming the skeleton of the self-doped conductive polymer) and the conjugated polymer formed by the electrolytic polymerization may be the same type or different types. The dopant used in the pre-coating treatment and the dopant used in the electrolytic polymerization may be the same or different.

The pre-coating treatment is performed by applying the liquid composition containing the conductive material (a conductive polymer or the like) to the anode body (specifically, the cathode formation part) including the dielectric layer and drying the composition. The application and drying of the liquid composition are preferably repeated twice or more. Even in a case where the anode body is the porous molded body or the porous sintered body, the application and drying of the liquid composition are repeated a plurality of times, and thus, the coverage of the surface including the inner wall of the void of the porous portion with the pre-coating layer can be increased. Accordingly, a more uniform and dense solid electrolyte can be formed at a high filling rate by electrolytic polymerization, and high stability and high conductivity of the first part can be easily ensured. The first part is formed at a high filling rate in the void, and thus, the flow of air is reduced. As a result, since the deterioration of the solid electrolyte in the first part in a case where the solid electrolytic capacitor is exposed to the high-temperature environment or high-temperature and high-humidity environment is suppressed, the fluctuation in the ESR can be reduced.

### (Second Part)

The second part may constitute a layer (solid electrolyte layer) as a whole. The second part may have at least one of the composition and the film property different from those of the first part, or be the same in both of the composition and the film property. The second part may include a plurality of layers. At least two layers of such plurality of layers may be different in at least one of the composition and the film property, or may be the same in both.

The solid electrolyte of the second part may be formed by chemical polymerization, general two-pole electrolytic polymerization, or a liquid dispersion. However, from the viewpoint of highly dispersing the dopant in the entire solid electrolyte, easily ensuring high conductivity, and easily suppressing the deterioration of the solid electrolyte, the second part is also preferably formed by the three-pole electrolytic polymerization.

The conjugated polymer contained in the second part may be selected, for example, from the conjugated polymers described for the first part. The Mw of the conjugated polymer may be selected from the range described for the first part. As the dopant, at least one type selected from the group consisting of the polymer anions described for the first part and an anion may be used. Examples of the anions include a sulfate ion, a nitrate ion, a phosphate ion, a borate ion, an organic sulfonate ion, and a carboxylate ion, without limitation to these particular examples. Examples of the dopant that generates sulfonate ions include p-toluenesulfonic acid and naphthalenesulfonic acid. From the viewpoint of better achieving stability, it is preferable to use a polymer anion.

In the second part, an amount of the dopant contained in the solid electrolyte may be, for example, in a range from 10 parts by mass to 1000 parts by mass, inclusive, in a range from 20 parts by mass to 500 parts by mass, inclusive, or in a range from 50 parts by mass to 200 parts by mass, inclusive, with respect to 100 parts by mass of the conjugated polymer.

The second part may be formed by using the liquid dispersion (or solution) containing the conjugated polymer and the dopant. In a case where the second part is formed by the electrolytic polymerization, the second part may be formed in the same manner as described for the first part. The polymerization voltage of the electrolytic polymerization may be in the range described for the first part, and may be in a range from 0.6 V to 1.5 V, inclusive, or may be in a range from 0.7 V to 1.2 V, inclusive.

### (Others)

Each of the first part and the second part may further contain at least one selected from the group consisting of a known additive and a known conductive material other than the conductive polymer, as necessary. Examples of the conductive material include at least one kind selected from the group consisting of conductive inorganic materials such as manganese dioxide and TCNQ complex salts.

Examples of the additive include a known additive (such as a coupling agent and a silane compound) added to the solid electrolyte, a known conductive material other than the conductive polymer, and a water-soluble polymer. Each of the first part and the second part (or each layer forming each of these parts) may contain one of these additives, or may contain two or more of these additives in combination. In a case where each of these parts includes a plurality of layers, each of such layers may contain the same additives or different additives.

Each of the first part and the second part may be a single layer or may include a plurality of layers. In a case where each of these parts includes a plurality of layers, the type, the composition, the content, and the like of the conductive polymer component, the additive, and the like contained in each of such layers may be different or the same, among the layers. A layer for improving adhesiveness may be disposed between the dielectric layer and the solid electrolyte.

The solid electrolytes constituting the first part and the second part can be distinguished by analysis of a sectional image using an electron probe micro analyzer (EPMA), for example. For example, the analysis using the EPMA at equal intervals is performed for a sectional image of the entire solid electrolyte layer, and a boundary between adjacent solid electrolytes is determined from a difference in wavelength of a characteristic X-ray at each measurement point. A sample for measurement is produced in the same procedure as in the case of a sample for measurement of a Raman spectrum.

### (Cathode Lead-Out Layer)

The cathode lead-out layer may include at least a first layer that is in contact with the solid electrolyte while covering at least a part of the solid electrolyte, and may include the first layer and a second layer covering the first layer. Examples of the first layer include a layer containing conductive particles, and a metal foil. Examples of the conductive particles include at least one kind selected from conductive carbon and metal powder. For example, the cathode lead-out layer may include a layer containing conductive carbon (also referred to as a carbon layer) as the first layer and a layer containing metal powder or metal foil as the second layer. In a case where a metal foil is used as the first layer, the metal foil may form the cathode lead-out layer.

Examples of the conductive carbon include graphite (for example, artificial graphite or natural graphite).

The layer containing metal powder, which is the second layer, may be formed by laying a composition containing metal powder as a layer, on a surface of the first layer, for example. Examples of such a second layer include a metal paste layer formed using a composition containing metal powder such as silver particles, and a resin (binder resin). Although a thermoplastic resin may be used for the resin, use of a thermosetting resin such as an imide resin or an epoxy resin is preferable.

In a case where a metal foil is used as the first layer, the metal is not limited to a particular kind of metal. It is preferable to use a valve metal such as aluminum, tantalum, or niobium, or an alloy containing the valve metal, for the metal foil. The metal foil may have a roughened surface, as necessary. The surface of the metal foil may be provided with an anodization film, and may be provided with a film of metal (dissimilar metal) different from the metal constituting the metal foil, or a nonmetal film. Examples of the dissimilar metal and the nonmetal include metal such as titanium, and nonmetal such as carbon (conductive carbon or the like).

A film of the dissimilar metal or the nonmetal (for example, conductive carbon) described above may form the first layer, and the metal foil described above may form the second layer.

### (Others)

The solid electrolytic capacitor includes at least one capacitor element. The solid electrolytic capacitor may be a wound capacitor, or may be either a chip capacitor or a stacked capacitor. The solid electrolytic capacitor may include a plurality of stacked capacitor elements, for example. In addition, the solid electrolytic capacitor may also include two or more wound capacitor elements. The configuration of the capacitor elements may be selected depending on the type of the solid electrolytic capacitor.

In the capacitor element, one end part of the cathode lead terminal may be electrically connected to the cathode lead-out layer. For example, a conductive adhesive is applied to the cathode lead-out layer, and the cathode lead terminal is bonded to the cathode lead-out layer with the conductive adhesive interposed therebetween. The anode lead terminal may be electrically connected at its one end part to the anode lead-out part of the anode body. The anode lead terminal and the cathode lead terminal each have the other end part that is drawn out from the resin exterior body or the case. The other end part of each terminal exposed from the resin exterior body or the case is used for solder connection to a substrate on which the solid electrolytic capacitor is to be mounted, for example. In addition, a case where the lead terminal is drawn out, an end surface of at least one of the anode part and the cathode part may be exposed from an outer surface of a sealing body to be electrically connected to the external electrode.

The capacitor element is sealed by the resin exterior body or the case. For example, the capacitor element and a material resin (for example, uncured thermosetting resin and filler) of the exterior body may be placed inside a mold, to seal the capacitor element with the resin exterior body using a transfer molding method, a compression molding method, or the like. At this time, a part on the other end part side of each of the anode lead terminal and the cathode lead terminal connected to the anode lead drawn out form the capacitor element is exposed from the mold. In addition, the solid electrolytic capacitor may be formed by accommodating the capacitor element in a bottomed case while the parts of the anode lead terminal and the cathode lead terminal, the parts being close to the respective other end parts thereof, are positioned close to an opening of the bottomed case, and sealing the opening of the bottomed case using a sealing body. A lead may have a wire shape or a frame shape (a lead frame or the like).

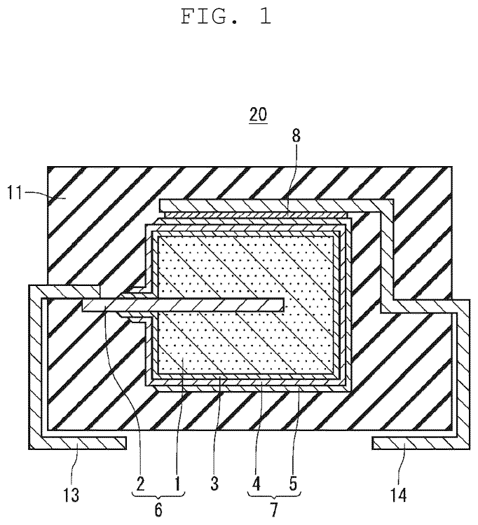

FIG. 1 is a schematic sectional view illustrating a solid electrolytic capacitor according to an exemplary embodiment of the present disclosure.

Solid electrolytic capacitor 20 includes capacitor element 10 including anode part 6 and cathode part 7, exterior body 11 that seals capacitor element 10, anode lead frame 13 electrically connected to anode part 6, and cathode lead frame 14 electrically connected to cathode part 7.

Anode part 6 includes anode body 1 and anode wire 2. A part of anode wire 2 is embedded in anode body 1, and a remaining part protrudes outward from an outer surface of anode body 1. The protruding part of anode wire 2 is joined to a part of a first part of anode lead frame 13 by welding or the like to be electrically connected thereto.

Dielectric layer 3 is formed on a surface of anode body 1. Cathode part 7 includes solid electrolyte layer 4 covering at least a part of dielectric layer 3, and cathode lead-out layer 5 covering at least a part of a surface of solid electrolyte layer 4. Cathode lead-out layer 5 includes a carbon layer formed to cover at least a part of the surface of solid electrolyte layer 4, and a metal particle-containing layer formed to cover at least a part of the carbon layer. Then, a part of a first part of cathode lead frame 14 is bonded to cathode lead-out layer 5 with conductive adhesive layer 8 interposed therebetween, and is electrically connected to cathode lead-out layer 5.

### EXAMPLES

The present invention will now be described specifically with reference to examples and comparative examples, but the present invention is not limited to the following examples.

### Examples 1 and 2 and Comparative Example 1

A capacitor element was produced in a manner to be described below, and characteristics of the capacitor element were evaluated.

### (1) Preparation of Anode Body Including Dielectric Layer

A tantalum sintered body (porous body) in which a part of an anode wire was embedded was prepared as an anode body. The tantalum sintered body was immersed in an anodizing solution, and was anodized by applying a DC voltage of 70 V for 20 minutes. In this way, a dielectric layer containing tantalum oxide was formed on the surface of the anode body.

### (2) Formation of Solid Electrolyte Layer

### (2-1) Pre-Coating Treatment

An aqueous dispersion containing a self-doped polythiophene-based polymer was prepared. A tantalum sintered body part (cathode formation part) of the anode body on which the dielectric layer obtained in the above (1) was formed was immersed in the aqueous dispersion for about 30 to 60 seconds, was taken out, and was dried under a reduced pressure. In solid electrolytic capacitors E1 and E2, immersion in the aqueous dispersion and drying were repeated a plurality of times. In this way, a pre-coating layer was formed in the solid electrolytic capacitor. Note that, a concentration of the polythiophene-based polymer in the aqueous dispersion was set to 1 mass %. PEDOT (Mw: about 10,000) having a sulfo group bonded to a PEDOT skeleton via a linking group including a butylene group was used as the self-doped polythiophene-based polymer.

### (2-2) Electrolytic Polymerization

A mixed solution was prepared by dissolving a 3,4-ethylenedioxythiophene monomer and polystyrene sulfonic acid (PSS, Mw: 100,000) as a polymer anion in ion-exchanged water. While the mixed solution is being stirred, iron (III) sulfate (oxidizing agent) dissolved in ion-exchanged water is added to the mixed solution to prepare a polymerization liquid. Using the obtained polymerization liquid, three-electrode electrolytic polymerization was carried out. More specifically, the anode body on which the pre-coating layer is formed, the counter electrode, and the reference electrode (silver/silver chloride reference electrode) were immersed in the polymerization liquid. A voltage was applied to the anode body such that the potential of the anode body with respect to the reference electrode was 1.1 V, and electrolytic polymerization was performed at 25° C.

In this way, the solid electrolyte layer was formed.

### (3) Formation of Cathode Lead-Out Layer

The anode body obtained in the above (2) was then immersed in a dispersion liquid containing graphite particles dispersed in water, was taken out from the dispersion liquid, and then dried, to form the first layer (carbon layer) at least on the surface of the solid electrolyte layer. Drying was performed at a temperature in a range from 130° C. to 180° C., inclusive, for 10 minutes to 30 minutes.

Next, a silver paste containing silver particles and a binder resin (epoxy resin) was applied onto a surface of the first layer, and heated at a temperature in a range from 150° C. to 200° C., inclusive, for 10 minutes to 60 minutes to cure the binder resin, whereby a second layer (metal particle-containing layer) was formed. In this manner, the cathode lead-out layer including the first layer (carbon layer) and the second layer (metal-particle-containing layer) was formed, and the cathode part including the solid electrolyte layer and the cathode lead-out layer was formed.

In this way, twenty capacitor elements in total were produced as described above.

### Reference Example 1

The solid electrolyte layer was formed by following the steps described below. A capacitor element was produced in the same manner as in Example 1 except for this formation of the solid electrolyte layer.

In the pre-coating treatment, in the same manner as in Comparative Example 1, immersion in the aqueous dispersion and drying were performed once. The electrolytic polymerization of pyrrole was performed by the following procedure by using the anode body after the pre-coating treatment.

A polymerization liquid containing pyrrole (monomer of a conjugated polymer), naphthalenesulfonic acid (dopant), and distilled water was prepared. Using the obtained polymerization liquid, three-electrode electrolytic polymerization was carried out. More specifically, the anode body on which the pre-coating layer is formed, the counter electrode, and the reference electrode (silver/silver chloride reference electrode) were immersed in the polymerization liquid. A voltage was applied to the anode body in a manner that the potential of the anode body with respect to the reference electrode is 0.9 V, and electrolytic polymerization was performed at 25° C. to form the solid electrolyte layer. The concentration of pyrrole in the polymerization liquid was about 1.3 mass %, and the concentration of the dopant was about 4 mass %.

### [Evaluation]

Using the solid electrolytic capacitors, the following evaluations were carried out.

### (a) Abundance Ratio of S Element in Porous Portion

Using the capacitor element, an EPMA analysis of a cross-section of the porous portion of the anode body was carried out, by following the steps described above, and the Net intensity of Ta element and S element was obtained from element mapping. The abundance ratio of S element was obtained from the Net intensity of these elements, by following the steps described above.

### (b) Raman Spectrum Measurement of Solid Electrolyte

Using the capacitor element of Example 1, the Raman spectrum of a cross-section of the first part of the solid electrolyte was measured following the steps above. In the Raman spectrum of the first part, a peak (first peak) unique to the 5-membered ring of PEDOT was observed at 1420 cm⁻¹, and a peak (second peak) unique to the aromatic ring-S element bond of PSS was observed at 1000 cm⁻¹. When the intensity Iₚ₁ of the first peak and the intensity Iₚ₂ of the second peak were obtained and the ratio Iₚ₁/Iₚ₂ was calculated, Li was 3545, Iₚ₂ was 659, and the ratio Iₚ₁/Iₚ₂ was 5.38.

### (c) ESR

In an environment of 20° C., initial ESR (mΩ) of the capacitor element at a frequency of 100 kHz was measured by using an LCR meter for 4-terminal measurement. Then, an average value (R0) of 20 capacitor elements was determined for the initial ESR.

Of the 20 capacitor elements whose initial ESR was measured, 10 capacitor elements were allowed to stand in an environment at 145° C. for 600 hours, and then cooled to 20° C. The ESR (mΩ) of the capacitor element after cooling was measured under the same conditions as in the initial ESR measurement to obtain an average value (R1) of 10 capacitor elements. Fluctuation amount 1 (mΩ) of the ESR was obtained by subtracting R0 from R1.

The remaining 10 capacitor elements were allowed to stand in an environment of 85° C. and 85% RH for 600 hours, and then cooled to 20° C. The ESR (mΩ) of the capacitor element after cooling was measured under the same conditions as in the initial ESR measurement to obtain an average value (R2) of 10 capacitor elements. Fluctuation amount 2 (mΩ) of the ESR was obtained by subtracting R0 from R2.

Evaluation results are shown in Table 1. Capacitor elements E1 and E2 are Examples 1 to 2, capacitor element C1 is Comparative Example 1, and capacitor element R1 is Reference Example 1. Fluctuation amounts 1 and 2 of the ESR are expressed as relative values when the fluctuation amount in Comparative Example 1 is 1.00.

TABLE 1

| | S element | Fluctuation amount 1 | Fluctuation amount 2 |
|---|---|---|---|
| | Abundance ratio | of ESR 145° C. | of ESR 85° C. 85% RH |
| | (%) | (relative value) | (relative value) |
| E1 | 0.24 | 0.61 | 0.27 |
| E2 | 0.17 | 0.58 | 0.21 |
| C1 | 0.14 | 1.00 | 1.00 |
| R1 | — | 22.44 | 2.05 |

As shown in Table 1, in the capacitor element in which the solid electrolyte layer is formed by electrolytic polymerization of pyrrole, the fluctuation amount of the ESR in a case where the solid electrolytic capacitor is exposed to the high temperature environment (or high-temperature and high-humidity environment) is very large (capacitor element R1). In capacitor element C1 in which the abundance ratio of S element in the first part is less than 0.17%, the fluctuation amount of the ESR is reduced as compared with capacitor element R1, but the fluctuation amount is still large. By contrast, in Examples (capacitor elements E1 and E2) in which the abundance ratio of S element in the first part is more than or equal to 0.17%, the fluctuation amount of the ESR is remarkably reduced, and it can be seen that excellent reliability can be obtained. Note that, in a case where the first part and the second part are formed by using the liquid dispersion containing PEDOT and PSS, it is difficult to dispose the solid electrolyte in the void of the porous portion at a high filling rate. Thus, the abundance ratio of S element in the first part is less than 0.14% of capacitor element C1, and fluctuation amounts 1 and 2 of the ESR are larger than those of capacitor element C1.

### INDUSTRIAL APPLICABILITY

According to the present disclosure, the fluctuation in the ESR when the solid electrolytic capacitor is exposed to the high-temperature environment (or high-temperature and high-humidity environment) can be reduced. Since the capacitor element and the solid electrolytic capacitor of the present disclosure can stably ensure low ESR even in a case where the solid electrolytic capacitor is exposed to the high-temperature environment (or high-temperature and high-humidity environment), the capacitor element and the solid electrolytic capacitor can be used for various applications in which heat resistance, moisture resistance, or reliability is required. However, the applications of the capacitor element and the solid electrolytic capacitor are not limited to these.

### REFERENCE MARKS IN THE DRAWINGS

20 solid electrolytic capacitor
10 capacitor element
1 anode body
2 anode wire
3 dielectric layer
4 solid electrolyte layer
5 cathode lead-out layer
6 anode part
7 cathode part
8 conductive adhesive layer
11 exterior body
13 anode lead frame
14 cathode lead frame

1. A solid electrolytic capacitor element comprising:
an anode body that includes a porous portion disposed at least in a surface layer of the anode body;
a dielectric layer that covers at least a part of a surface of the anode body; and
a solid electrolyte that covers at least a part of the dielectric layer, wherein:
the anode body contains tantalum element,
the solid electrolyte contains sulfur element,
the solid electrolyte includes a first part disposed in a void of the porous portion and a second part disposed in an outside of the porous portion that is outer from a principal surface of the anode body including the dielectric layer, and
in element mapping of a predetermined region of a cross-section of the porous portion using an electron probe micro analyzer, an abundance ratio of sulfur element is more than or equal to 0.17% with respect to an abundance ratio of tantalum element of 100%.

2. The solid electrolytic capacitor element according to claim 1, wherein the first part includes a first polymer component corresponding to a conjugated polymer and a second polymer component corresponding to a polymer anion containing sulfur element.

3. The solid electrolytic capacitor element according to claim 2, wherein the first polymer component contains sulfur element.

4. The solid electrolytic capacitor element according to claim 2, wherein, in a Raman spectrum of the first part, a ratio Iₚ₁/Iₚ₂ of an intensity Iₚ₁ of a first peak unique to the first polymer component to an intensity Iₚ₂ of a second peak unique to the second polymer component is more than or equal to 2.

5. The solid electrolytic capacitor element according to claim 4, wherein the ratio Iₚ₁/Iₚ₂ is less than or equal to 7.

6. The solid electrolytic capacitor element according to claim 2, wherein:
in the first part, the conjugated polymer includes a monomer unit corresponding to a thiophene compound, and the polymer anion includes a monomer unit corresponding to an aromatic sulfonic acid compound, and
in a Raman spectrum of the first part, a first peak unique to the first polymer component is observed in a range from 1200 cm⁻¹ to 1600 cm⁻¹, inclusive, and a second peak unique to the second polymer component is observed in a range from 800 cm⁻¹ to 1100 cm⁻¹, inclusive.

7. The solid electrolytic capacitor element according to claim 2, wherein a weight-average molecular weight of the polymer anion is in a range from 100 to 500,000, inclusive.

8. The solid electrolytic capacitor element according to claim 1, wherein the anode body is a porous sintered body.

9. A solid electrolytic capacitor comprising the solid electrolytic capacitor element according to claim 1.
